(19) United States
(12) Patent Application Publication
(10) Pub. No.: US 2024/0064494 A1
(43) Pub. Date: Feb. 22, 2024

(54) SYSTEMS AND METHODS FOR DEVICE TRIGGERING FOR 5G DEVICES

(71) Applicant: Telefonaktiebolaget LM Ericsson (publ), Stockholm (SE)

(72) Inventor: Hongxia LONG, Shanghai (CN)

(21) Appl. No.: 18/260,954

(22) PCT Filed: Jan. 14, 2022
(86) PCT No.: PCT/CN2022/072000

§ 371 Date: Jul. 11, 2023

(30) Foreign Application Priority Data
Jan. 14, 2021 (WO) PCT/CN2021/071671

(51) Int. Cl. H04W 4/14; H04W 60/04

(52) U.S. Cl. CPC H04W 4/14; H04W 60/04

(57) ABSTRACT

Systems and methods for device triggering for Fifth Generation (5G) devices are provided. In a some embodiments, a method at a core network node for device triggering for 5G devices includes at least one of: receiving a request to trigger a 5G device; and transmitting a Device Trigger Request message to a Short Message Service-Service Center (SMS-SC) with one or more SMS serving node identities to trigger the 5G device. This provides support for the device trigger procedure when the UE device is located in a 5G system.

### TECHNICAL FIELD

The present disclosure relates to triggering devices.

### BACKGROUND

In a 3rd Generation Partnership Project (3GPP) network (Universal Mobile Telecommunications Service (UMTS) Terrestrial Radio Access Network (UTRAN), Evolved UTRAN (E-UTRAN), GERAN (Global System for Mobile Communications Enhanced Data Rates for Global System for Mobile Communications Evolution Radio Access Network), etc.), a User Equipment (UE) may need to be triggered. In some systems, a Machine Type Communication (MTC) UE needs to be triggered by an MTC application on an Application Server (AS) inside the 3GPP operator domain or in the external network which utilizes the Services Capability Server (SCS). There are three different deployment models. In the Direct Model, the AS connects directly to the operator network and performs direct user plane communications with the UE. In the Indirect Model, the AS connects indirectly to the operator network by using the SCS. This SCS can be controlled by the 3GPP operator or a MTC service provider of the external network. In the Hybrid Model, the AS uses both the direct and indirect models.

Fifth Generation (5G) networks still have a need to trigger UEs, but challenges exist. As such, improved systems and methods for device triggering for 5G devices are needed.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Systems and methods for device triggering for Fifth Generation (5G) devices are provided. In some embodiments, a method at a core network node for device triggering for 5G devices includes at least one of: receiving a request to trigger a 5G device; and transmitting a Device Trigger Request message to a Short Message Service-Service Center (SMS-SC) with one or more SMS serving node identities to trigger the 5G device. This provides support for the device trigger procedure when the UE device is located in a 5G system.

In some embodiments, the core network node is one of: a Machine Type Communication-InterWorking Function (MTC-IWF); a Service Capability Exposure Function (SCEF); and a Network Exposure Function (NEF).

In some embodiments, the request to trigger the 5G device is received from one of: an Application Server (AS); a Service Capability Server (SCS); and an Application Function (AF).

In some embodiments, the request to trigger the 5G device comprises a Device Action Request.

In some embodiments, the request to trigger the 5G device comprises one or more of: an application identity; a trigger payload; and an identity of the 5G device.

In some embodiments, the Device Trigger Request message comprises one or more of: an application identity; a trigger payload; and an identity of the 5G device.

In some embodiments, the method also includes, prior to transmitting the Device Trigger Request message, requesting 5G domain UE registered Short Message Service Function (SMSF) identities for the 5G device.

In some embodiments, the method also includes, prior to transmitting the Device Trigger Request message, receiving 5G domain UE registered SMSF identities for the 5G device.

In some embodiments, requesting the 5G domain UE registered SMSF identities and/or receiving the 5G domain UE registered SMSF identities comprises requesting and/or receiving the 5G domain UE registered SMSF identities from a Unified Data Management (UDM) node.

In some embodiments, the method also includes, prior to transmitting the Device Trigger Request message, selecting a suitable SMS-SC based on configured information.

In some embodiments, selecting the suitable SMS-SC based on one or more of: the identity of the 5G device; the application identity; load balancing; and/or how close the SMS-SC is.

This can enhance the T4 device trigger request from MTC-InterWorking Function (MTC-IWF)/SCEF/NEF to the Short Message Service Center (SMSC) by extending the protocol information elements for containing of SMSF for 3GPP access and/or SMSF for non-3GPP access, and the corresponding SMSF address could either be a MAP number address or a Diameter address in the form of a combination of name and realm. This provides support for the device trigger procedure when the UE device is located in a 5G system.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system according to some embodiments of the present disclosure;

FIGS. 2 and 3 illustrate example embodiments in which the cellular communication system of FIG. 1 is a Fifth Generation (5G) System (5GS);

FIGS. 4 and 5 illustrate the architecture for a UE used for MTC connecting to the 3GPP network;

FIGS. 6 and 7 illustrate the operation of nodes in a 5G system according to some embodiments of the present disclosure;

FIG. 8 illustrates a Device Trigger for a UE located in a 5G system according to some embodiments of the present disclosure;

FIG. 9 is a schematic block diagram of a core network node according to some embodiments of the present disclosure;

FIG. 10 is a schematic block diagram of a radio access node according to some embodiments of the present disclosure;

FIG. 11 is a schematic block diagram that illustrates a virtualized embodiment of the radio access node of FIG. 10 according to some embodiments of the present disclosure;

FIG. 12 is a schematic block diagram of the radio access node of FIG. 10 according to some other embodiments of the present disclosure;

FIG. 13 is a schematic block diagram of a User Equipment device (UE) according to some embodiments of the present disclosure;

FIG. 14 is a schematic block diagram of the UE of FIG. 13 according to some other embodiments of the present disclosure;

FIG. 15 illustrates a telecommunication network connected via an intermediate network to a host computer in accordance with some embodiments of the present disclosure;

FIG. 16 is a generalized block diagram of a host computer communicating via a base station with a UE over a partially wireless connection in accordance with some embodiments of the present disclosure;

FIG. 17 is a flowchart illustrating a method implemented in a communication system in accordance with one embodiment of the present disclosure;

FIG. 18 is a flowchart illustrating a method implemented in a communication system in accordance with one embodiment of the present disclosure;

FIG. 19 is a flowchart illustrating a method implemented in a communication system in accordance with one embodiment of the present disclosure; and

FIG. 20 is a flowchart illustrating a method implemented in a communication system in accordance with one embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

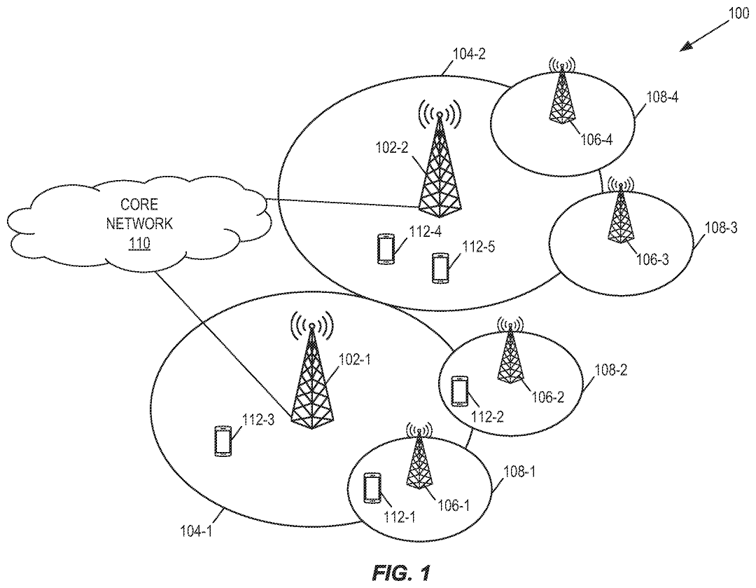

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC). In this example, the RAN includes base stations 102-1 and 102-2, which in the 5GS include NR base stations (gNBs) and optionally next generation eNBs (ng-eNBs) (e.g., LTE RAN nodes connected to the 5GC), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

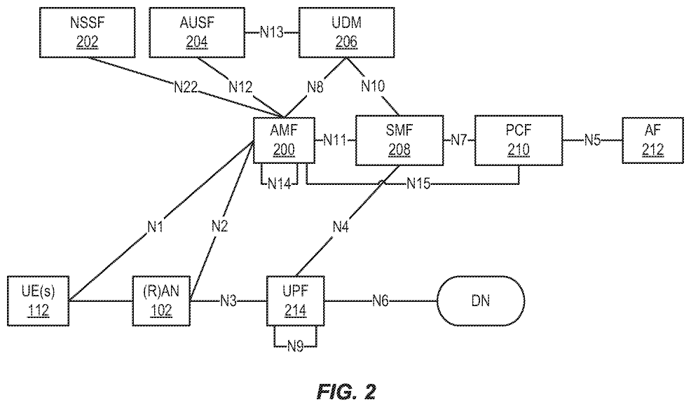

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the system 100 of FIG. 1.

Seen from the access side the 5G network architecture shown in FIG. 2 comprises a plurality of UEs 112 connected to either a RAN 102 or an Access Network (AN) as well as an AMF 200. Typically, the R(AN) 102 comprises base stations, e.g., such as eNBs or gNBs or similar. Seen from the core network side, the 5GC NFs shown in FIG. 2 include a NSSF 202, an AUSF 204, a UDM 206, the AMF 200, a SMF 208, a PCF 210, and an Application Function (AF) 212.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208.

The 5GC network aims at separating UP and CP. The UP carries user traffic while the CP carries signaling in the network. In FIG. 2, the UPF 214 is in the UP and all other NFs, i.e., the AMF 200, SMF 208, PCF 210, AF 212, NSSF 202, AUSF 204, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

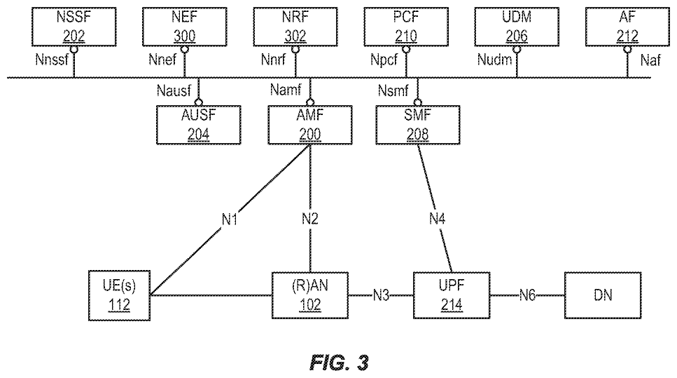

FIG. 3 illustrates a 5G network architecture using service-based interfaces between the NFs in the CP, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g., Namf for the service based interface of the AMF 200 and Nsmf for the service based interface of the SMF 208, etc. The NEF 300 and the NRF 302 in FIG. 3 are not shown in FIG. 2 discussed above. However, it should be clarified that all NFs depicted in FIG. 2 can interact with the NEF 300 and the NRF 302 of FIG. 3 as necessary, though not explicitly indicated in FIG. 2.

Some properties of the NFs shown in FIGS. 2 and 3 may be described in the following manner. The AMF 200 provides UE-based authentication, authorization, mobility management, etc. A UE 112 even using multiple access technologies is basically connected to a single AMF 200 because the AMF 200 is independent of the access technologies. The SMF 208 is responsible for session management and allocates Internet Protocol (IP) addresses to UEs. It also selects and controls the UPF 214 for data transfer. If a UE 112 has multiple sessions, different SMFs 208 may be allocated to each session to manage them individually and possibly provide different functionalities per session. The AF 212 provides information on the packet flow to the PCF 210 responsible for policy control in order to support QoS. Based on the information, the PCF 210 determines policies about mobility and session management to make the AMF 200 and SMF 208 operate properly. The AUSF 204 supports authentication function for UEs or similar and thus stores data for authentication of UEs or similar while the UDM 206 stores subscription data of the UE 112. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

In a 3GPP network (Universal Mobile Telecommunications Service (UMTS) Terrestrial Radio Access Network (UTRAN), Evolved UTRAN (E-UTRAN), GERAN, etc.), a UE may need to be triggered. In some systems, a MTC UE needs to be triggered by an MTC application on an Application Server (AS) inside the 3GPP operator domain or in the external network which utilizes the Services Capability Server (SCS). There are three different deployment models. In the Direct Model, the AS connects directly to the operator network and performs direct user plane communications with the UE. In the Indirect Model, the AS connects indirectly to the operator network by using the SCS. This SCS can be controlled by the 3GPP operator or a MTC service provider of the external network.

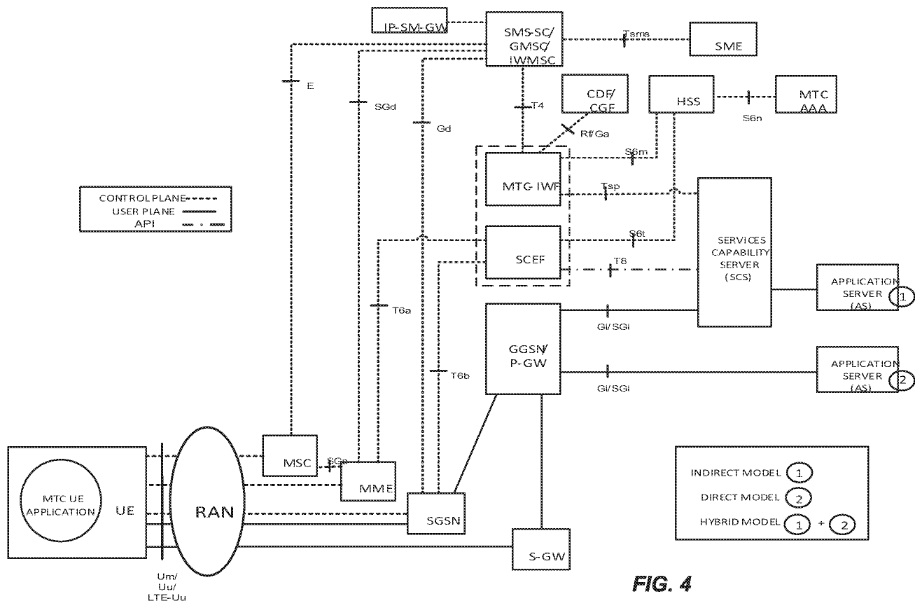

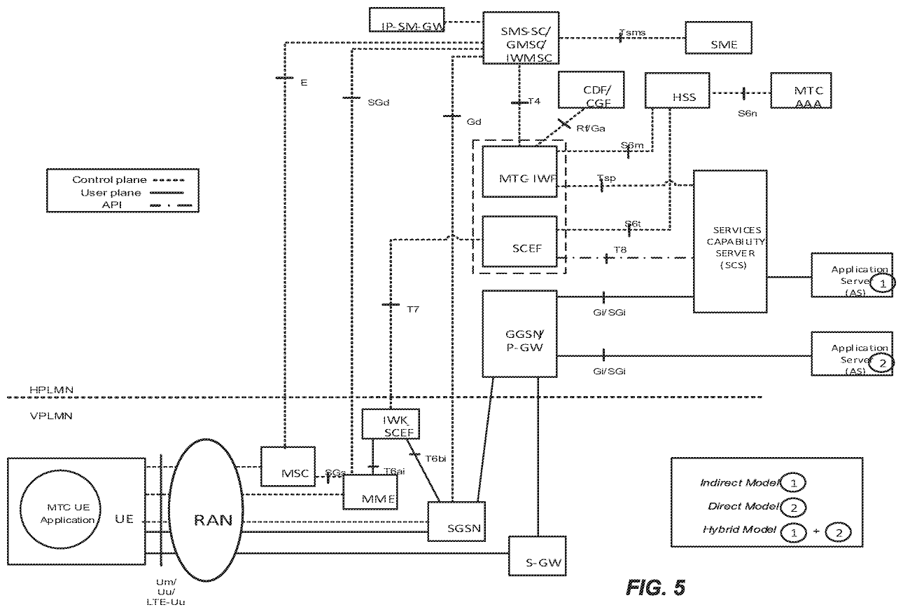

FIG. 4 and FIG. 5 show the architecture for a UE used for MTC connecting to the 3GPP network (UTRAN, E-UTRAN, GERAN, etc.) via the Um/Uu/LTE-Uu interfaces. They also show the 3GPP network service capability exposure to SCS and AS. These figures are based on FIGS. 4.2-1a and 4.2-1b from 3GPP 23.682.

In order to create a new device trigger, the SCS/AS shall send an HTTP POST message to the SCEF for the “Device Triggering Transactions” resource. The body of the HTTP POST message shall include the External Identifier or Mobile Subscriber Integrated Services Digital Network (MSISDN) validity period, priority, Application Port ID and trigger payload.

In some situations, the SCS/AS delivers the device trigger via T8 interface. The SCS/AS can perform the specific actions by sending triggers via the 3GPP network, even when the MTC UE's IP address is not available or reachable by the SCS/AS. For example, this function can initiate the communication between the MTC UE and the SCS/AS. The MTC UE's subscription includes whether the UE is allowed to be triggered by a specific SCS. An MTC UE may receive the device triggering message in different scenarios.

The T4 reference point transfers the device trigger from MTC-IWF (acting as a Short Message Entity (SME)) to Short Message Service-Service Center (SMS-SC), provides serving node's information corresponding to International Mobile Subscriber Identity (IMSI), and reports the success or failure of delivering a device trigger to the MTC UE.

Upon receipt of the corresponding HTTP POST message, the SCEF shall check if the SCS/AS is authorized to send a trigger request and if the SCS/AS has exceeded its quota or rate of trigger submission. The SCEF shall also resolve the External Identifier or MSISDN to IMSI and retrieve the “Routing Information” from HSS for the triggering delivery. If the authorization check fails, or if the quota or rate of trigger submission was exceeded, or if there is no valid subscription information or if the “Routing Information” cannot be found, then the SCEF shall reject the request with an error message to the SCS/AS. Otherwise, the SCEF shall perform the device trigger procedure over Tsp as defined in 3GPP TS 29.368 and T4 as defined in 3GPP TS 29.337. Upon completion of this procedure, the SCEF shall create a resource “Individual Device Triggering Transaction” which represents the triggering transaction, addressed by a Uniform Resource Identifier (URI) that contains the SCS/AS identity and an SCEF-created transaction identifier, and shall respond to the SCS/AS with a 201 Created message, including the trigger and a Location header field containing the URI for the created resource. The SCS/AS shall use the URI received in the Location header in subsequent requests to the SCEF to refer to this device triggering transaction. A Tsp peer-to-peer connection is a connection between SCS and MTC-InterWorking Function (MTC-IWF).

In order to replace an existing device trigger, the SCS/AS shall send an HTTP PUT message to the SCEF for the “Individual Device Triggering Transaction” resource, using the URI received in the response to the request that has created the device triggering transaction resource. The body of the HTTP PUT message shall include External Identifier or MSISDN, validity period, priority, Application Port ID and trigger payload.

After receiving the corresponding HTTP PUT message from the SCS/AS, the SCEF shall check if the SCS/AS is authorized to replace an existing device trigger and if the SCS/AS has not exceeded its quota or rate of trigger submission. If any of these checks fail, then the SCEF shall reject the message with an error. Otherwise, the SCEF shall replace the device triggering with the SMS-SC by performing the device trigger replace procedure over Tsp as defined in 3GPP TS 29.368 and T4 as defined in 3GPP TS 29.337. Upon completion of this procedure, the SCEF shall send an HTTP response to the SCS/AS to indicate trigger replace success or failure.

In order to recall an existing device trigger, the SCS/AS shall send an HTTP DELETE message to the SCEF for the “Individual Device Triggering Transaction” resource, using the URI received in the response to the request that has created the device triggering transaction resource.

After receiving the corresponding HTTP DELETE message from the SCS/AS, the SCEF shall check if the SCS/AS is authorized to send a recall trigger request and if the SCS/AS has not exceeded its quota or rate of trigger submission. The SCEF shall also check if the device triggering transaction resource referenced by the URI exists. If any of these checks fail, then the SCEF shall reject the message with an error. Otherwise, the SCEF shall recall the device triggering with the SMS-SC by performing the device trigger replace procedure over Tsp as defined in 3GPP TS 29.368 and T4 as defined in 3GPP TS 29.337. Upon completion of this procedure, the SCEF shall send an HTTP response to the SCS/AS to indicate trigger recall success or failure.

When it receives the Message Delivery Report from the SMS/SC, the SCEF shall send an HTTP POST message to the SCS/AS to report the trigger delivery result. The body of the HTTP POST message shall include the identifier if the transaction and cause. The SCS/AS shall respond with an HTTP 200 OK or 204 No Content response.

The procedures for device triggering as described in subclause 4.4.6 of 3GPP TS 29.122 shall be applicable in 5G with the following differences:
description of the SCS/AS applies to the AF;
description of the SCEF applies to the NEF;
description of the HSS applies to the UDM;
the NEF shall interact with the UDM by using the Nudm_SubscriberDataManagement service and the Nudm_UEContextManagement service as defined in 3GPP TS 29.503; and the NEF acts as MTC-IWF.

MTC-IWF is a standalone functional entity or part of another network entity. Mainly it supports the device trigger functionality over Tsp and T4 reference points. Additionally, it can generate the Charging Data Records (CDRs) for the device trigger over Rf/Ga.

Device Trigger Procedure (from 29.337 5.2.1): This procedure shall be used between the MTC-IWF and the SMS-SC for device trigger. The procedure shall be invoked by the MTC-IWF and is used:
to transfer device trigger to SMS-SC inside Home Public Land Mobile Network (HPLMN) domain;
to transfer to the SMS-SC the identities of the serving Mobile Switching Center (MSC) or MME but not both, and/or Serving General Packet Radio Service Support Node (SGSN), and/or IP-Short-Message-Gateway (IP-SM-GW) serving the user for SMS along with device trigger.
to transfer device trigger replace/recall message to SMS-SC inside HPLMN domain.

This procedure is mapped to the commands Device-Trigger-Request/Answer in the Diameter application specified in chapter 6. Tables 1 (from 5.2.1.1/1) and 2 (from 5.2.1.1/2) detail the involved information elements.

TABLE 1
From Table 5.2.1.1/1: Device Trigger Request

| Information | Mapping to | | |
|---|---|---|---|
| Element Name | Diameter AVP | Cat. | Description |
| User Identifier | User- | M | This information element shall contain the IMSI |
| (See 3GPP TS | Identifier | | of the UE the trigger is to be applied, |
| 29.336 [12]) | | | formatted according to 3GPP TS 23.003 [8], |
| | | | clause 2.2. |
| | | | This Information Element may contain the |
| | | | international ISDN number of the UE the |
| | | | device trigger was delivered, formatted |
| | | | according to 3GPP TS 23.003 [8], clause 3.3. |
| | | | The ISDN number shall be present if it is |
| | | | available to the MTC-IWF. |
| | | | This Information Element may contain the |
| | | | external identifier of the UE the device trigger |
| | | | was delivered, formatted according to 3GPP TS |
| | | | 23.003 [8], clause 19.7.2. The external |
| | | | identifier shall be present if it is available |
| | | | to the MTC-IWF. |
| SM RP SMEA | SM-RP-SMEA | M | This Information Element shall contain the SME |
| (See 3GPP TS | | | address of the Service Capability Server that is |
| 29.338 [13]) | | | requesting a device trigger to the UE. It shall |
| | | | be encoded according to the formatting rules |
| | | | of the address fields described in |
| | | | 3GPP TS 23.040 [9]. |
| Payload (See | Payload | M | This information element shall contain the |
| 3GPP TS 29.368 | | | device triggering payload as received over the |
| [15]) | | | Tsp. |
| | | | For device trigger recall, this IE shall be empty. |
| Serving Node | Serving-Node | C | This information element shall contain the |
| Identity | | | serving node identity, i.e., SGSN/MME/MSC |
| (See 3GPP TS | | | identity serving the UE. |
| 29.173 [14]) | | | It shall be present if it is available to the MTC- |
| | | | IWF, e.g., the MTC-IWF retrieved this |
| | | | information from the HSS. |
| Additional | Additional- | C | This information element shall contain another |
| Serving Node | Serving-Node | | serving node identity, e.g., SGSN/MME/MSC |
| Identity | | | identity, if there is any serving the UE. |
| (See 3GPP TS | | | There may be multiple instances of this |
| 29.173 [14]) | | | information elements. |
| Trigger | Reference- | C | This information element shall contain the |
| Reference | Number | | Reference Number related to the device trigger |
| Number | | | request. |
| (See 3GPP TS | | | It shall be present if it is available to the MTC- |
| 29.368 [15]) | | | IWF, e.g., the MTC-IWF received this |
| | | | information over Tsp. |
| Old Trigger | Old- | C | This information element shall contain the |
| Reference | Reference- | | Reference Number of the device trigger to be |
| Number | Number | | replaced. |
| (See 3GPP TS | | | It shall be present if it is available to the MTC- |
| 29.368 [15]) | | | IWF, e.g., the MTC-IWF received this |
| | | | information over Tsp. |
| Validity Time | Validity-Time | C | This information element shall contain the |
| (See 3GPP TS | | | validity time of the device trigger request. |
| 29.368 [15]) | | | It shall be present if it is available to the MTC- |
| | | | IWF, e.g., the MTC-IWF received this |
| | | | information over Tsp. |
| Priority | Priority- | C | This information element shall contain the |
| Indication | Indication | | priority of the device trigger request. |
| (See 3GPP TS | | | It shall be present if it is available to the MTC- |
| 29.368 [15]) | | | IWF, e.g., the MTC-IWF received this |
| | | | information over Tsp. |
| SMS Application | SMS- | C | This information element shall contain the |
| Port ID | Application- | | Application Port ID of the triggering application |
| (See 3GPP TS | Port-ID | | for the device trigger request. |
| 29.368 [15]) | | | It shall be present if it is available to the MTC- |
| | | | IWF, e.g., the MTC-IWF received this |
| | | | information over Tsp. |
| Supported | Supported- | O | If present, this information element shall |
| Features | Features | | contain the list of features supported by the |
| (See 3GPP TS | | | origin host. |
| 29.229 [6]) | | | |
| Trigger-Action | Trigger- | C | This information element shall be present for |
| (See 6.3.6) | Action | | device trigger action replace or recall. |
| | | | This information element may be present for a |
| | | | normal device. |

TABLE 2
From Table 5.2.1.1/22: Device Trigger Answer

| Information | Mapping to | | |
|---|---|---|---|
| Element Name | Diameter AVP | Cat. | Description |
| Result | Result-Code | M | This IE shall contain the result of the operation. |
| (See 7) | Experiment | | The Result-Code AVP shall be used to indicate |
| | al-Result | | success / errors as defined in the Diameter base |
| | | | protocol (see IETF RFC 6733 [19]). |
| | | | The Experimental-Result AVP shall be used for T4 |
| | | | errors. This is a grouped AVP which shall contain the |
| | | | 3GPP Vendor ID in the Vendor-Id AVP, and the error |
| | | | code in the Experimental-Result-Code AVP. |
| | | | The following errors are applicable: |
| | | | Service Centre Congestion; |
| | | | Invalid Short Message Entity Address; |
| | | | Subscriber not Service Centre Subscriber; |
| | | | SM Protocol Error; |
| | | | Trigger Replace failed; |
| | | | Trigger Recall failed; |
| | | | Original Message not pending. |
| MTC-Error- | MTC-Error- | 0 | If the Experimental Result indicates either |
| Diagnostic | Diagnostic | | “DIAMETER_ERROR_TRIGGER_REPLACE_FAILURE” |
| | | | or |
| | | | “DIAMETER_ERROR_ORIGINAL_MESSAGE_NOT_PENDING”, |
| | | | Error Diagnostic may be present to indicate |
| | | | the reason why the replace has failed. |
| Supported | Supported- | O | If present, this information element shall contain the |
| Features | Features | | list of features supported by the origin host. |
| (See 3GPP | | | |
| TS 29.229 | | | |
| [6]) | | | |
| Old Trigger | Old- | C | This information element shall be included if the |
| Reference | Reference- | | SMS-SC was requested to perform device trigger |
| Number | Number | | recall or replace. It shall contain the Reference |
| (See 3GPP | | | Number of the device trigger which was intended to |
| TS 29.368 | | | be replaced or recalled in the request. |
| [15]) | | | |
| Trigger- | Trigger- | C | This information element shall be present for device |
| Action | Action | | trigger action replace or recall. |
| (see 6.3.6) | | | This information element may be present for a |
| | | | normal device trigger. |

The MTC-IWF shall make use of this procedure to transfer device trigger request received over Tsp interface from SCS to the SMS-SC. If the MTC-IWF retrieved the IMSI and serving node identities of the UE from the HSS, the MTC-IWF shall include these identities in the request to the SMS-SC. The MTC-IWF shall include the External Identifier of the UE if received over Tsp interface from SCS. The MTC-IWF shall include the Old Trigger Reference Number if received over Tsp interface from SCS.

When receiving a Device Trigger Request, the SMS-SC shall check the identity of the UE received (i.e., IMSI or MSISDN) if it serves this UE. If not, a Result Code of DIAMETER_ERROR_USER_UNKNOWN shall be returned. If the SM-RP-SMEA AVP contains an invalid SME address, the SMS-SC shall return a Result Code of DIAMETER_ERROR_INVALID_SME_ADDRESS.

If the SMS-SC cannot fulfil the received request due to congestion, it shall return a Result Code of DIAMETER_ERROR_SC_CONGESTION. If there are routing information (i.e. MSC or MME, SGSN, IP-Short-Message-Gateway (IP-SM-GW) identities serving the UE for SMS) present in the request, the SMS-SC shall use the information for delivery of device trigger request for the UE. The SMS-SC shall return a Result Code of DIAMETER_SUCCESS to the MTC-IWF.

NOTE: If the IP-SM-GW address is received, the SMS-SC uses the IP-SM-GW as the serving node with highest priority for delivery of device trigger request for the UE.

If there is no routing information (i.e., MSC or MME, SGSN, IP-SM-GW identities serving the UE for SMS) present in the request, the SMS-SC shall send a Report-SM-Delivery-Status message to the Home Location Register (HLR) in order to update the Messages Waiting Data (MWD) in the HLR (see 3GPP TS 23.040).

If Trigger-Action is received from the MTC-IWF and set to TRIGGER (0), SMS-SC shall store the new trigger message received from MTC-IWF. If Trigger-Action is received from the MTC-IWF and set to RECALL (1), SMS-SC checks if message corresponding to Reference-Number is pending. If trigger message is pending then SMS-SC deletes the old trigger message. The SMS-SC shall return Old-Reference-Number and a Result Code of DIAMETER_SUCCESS to the MTC-IWF. For the successful scenario the SMS-SC is not required to initiate a device trigger reporting to the device trigger of Old-Reference-Number. If trigger message is not pending then SMS-SC shall return a Result Code of DIAMETER_ERROR_ORIGINAL_MESSAGE_NOT_PENDING to the MTC-IWF.

If Trigger-Action is received from the MTC-IWF and set to REPLACE (2), SMS-SC checks if message corresponding to Old-Reference-Number is pending. If trigger message is pending then SMS-SC shall delete the old trigger message and store the new trigger message received from MTC-IWF. The SMS-SC shall return OLD-Reference-Number and a Result Code of DIAMETER_SUCCESS to the MTC-IWF. For the successful scenario the SMS-SC is not required to initiate a device trigger reporting to the device trigger of Old-Reference-Number. If trigger message is not pending then SMS-SC shall return OLD-Reference-Number and a Result Code of DIAMETER_ERROR_ORIGINAL_MESSAGE_NOT_PENDING to the MTC-IWF and shall interpret the trigger replace message as a new device trigger. If the SMS-SC fails to perform deletion of the old trigger or fails to store the new trigger, it shall not delete the old trigger and shall not store the new trigger and shall return result code of DIAMETER_ERROR_TRIGGER_REPLACE_FAILURE.

The SMS SC shall use the most appropriate cause code indicating the real reason for the unsuccessful handling of the request message.

If the SMS-SC cannot fulfil the received request for reasons not stated in the above steps, e.g., due to system failure, it shall stop processing the request and set Result-Code to DIAMETER_UNABLE_TO_COMPLY.

Based on the description above, the device triggering procedures in T4 interface only consider the routing information of pre-5G mobile systems (i.e., MSC or MME, SGSN, IP-SM-GW identities serving the UE for SMS). When the UE is present in the 5G system, the new SMS serving nodes are SMSF for 3GPP access and/or SMSF for non-3GPP access. As such, device trigger cannot be supported if UE is in 5G system as T4 device trigger signaling cannot support SMS targeting nodes in 5G domain, i.e., SMSF for 3GPP access and/or SMSF for non-3GPP access. However, 5G networks still have a need to trigger UEs. As such, improved systems and methods for device triggering for 5G devices are needed.

Systems and methods for device triggering for Fifth Generation (5G) devices are provided. In some embodiments, a method at a core network node for device triggering for 5G devices includes at least one of: receiving a request to trigger a 5G device; and transmitting a Device Trigger Request message to a SMS-SC with one or more SMS serving node identities to trigger the 5G device. This provides support for the device trigger procedure when the UE device is located in a 5G system.

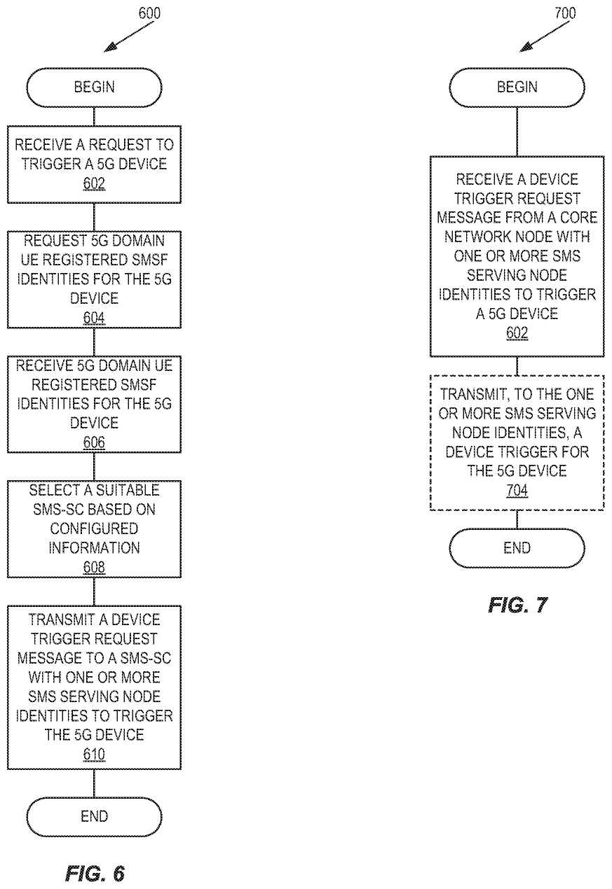

FIGS. 6 and 7 illustrate the operation of nodes in a 5G system according to some embodiments of the present disclosure. 600 is a method at a core network node for device triggering for 5G devices, comprising at least one of: receiving (602) a request to trigger a 5G device; optionally requesting (604) 5G domain UE registered SMSF identities for the 5G device; optionally receiving (606) 5G domain UE registered SMSF identities for the 5G device; optionally selecting (608) a suitable SMS-SC based on configured information; and transmitting (610) a Device Trigger Request message to a SMS-SC with one or more SMS serving node identities to trigger the 5G device. 700 is a method at a SMS-SC for device triggering for 5G devices, comprising at least one of: receiving (702) a Device Trigger Request message from a core network node with one or more SMS serving node identities to trigger a 5G device; and transmitting (704), to the one or more SMS serving node identities, a device trigger for the 5G device.

This enhances the T4 device trigger request from MTC-IWF/SCEF/NEF to SMSC by extending the protocol information elements for containing of SMSF for 3GPP access and/or SMSF for non-3GPP access, and the corresponding SMSF address could either be a MAP number address or a Diameter address in the form of a combination of name and realm. This enables support for the device trigger procedure when the UE device is located in a 5G system.

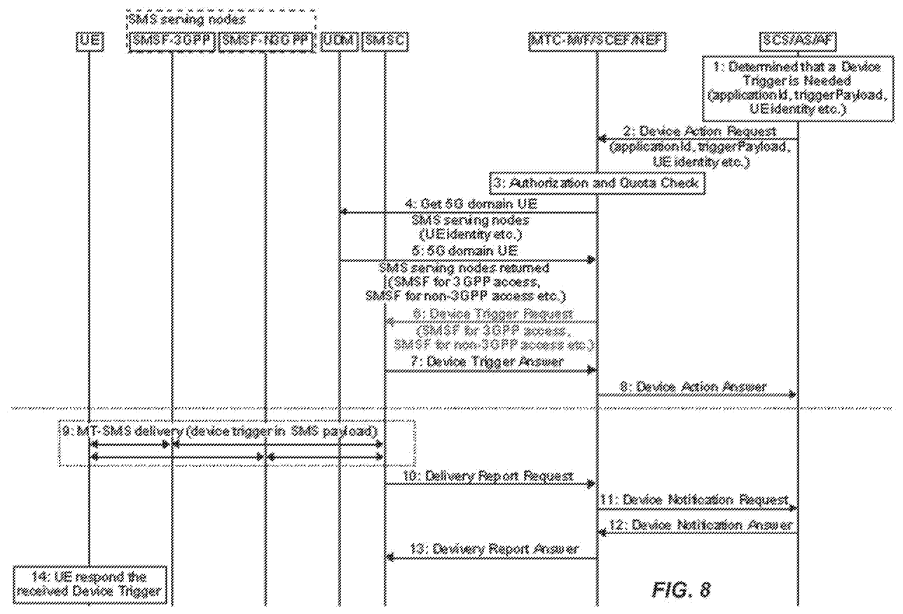

FIG. 8 illustrates a Device Trigger for a UE located in a 5G system according to some embodiments of the present disclosure. Some of these steps can be omitted and others can be performed in a different way. In Step 1, the AS/SCS/AF determines that a device trigger is needed. If the AS/SCS/AF has no contact details for the MTC-IWF/SCEF/NEF, it shall discover and select MTC-IWF/SCEF/NEF services. In Step 2, the AS/SCS/AF invokes the device trigger delivery request to MTC-IWF/SCEF/NEF.

In Step 3, the MTC-IWF/SCEF/NEF checks that the AS/SCS/AF is authorized to send device trigger requests and that the AS/SCS/AF has not exceeded its quota or rate of trigger submission over MTC-IWF/SCEF/NEF. If this check succeeded, the MTC-IWF/SCEF/NEF continues to check the SMS serving nodes for the UE. For devices registered in 5G system, UDM shall be interrogated to get 5G domain service nodes identities, which includes the registered SMSF identity for 3GPP access and/or the registered SMSF identify for non-3GPP access. In some embodiments, there might be multiple interrogations. This might be to obtain additional 5G domain service nodes identities.

In Step 4, the MTC-IWF/SCEF/NEF invokes Get UE context in SMSF request to UDM to retrieve the 5G domain UE registered SMSF identities. Before this step, MTC-IWF/SCEF/NEF may invoke the identity translation service to translate an external UE identity (such as MSISDN) into an internal identity (such as a Subscriber Permanent Identifier (SUPI)). The UDM further may invoke a Unified Data Repository (UDR) query service to retrieve the UE registered SMSF identities from UDR.

In Step 5, the UDM provides a Get UE context in SMSF response with the corresponding UE registered SMSF identities, which includes the registered SMSF identity for 3GPP access and/or the registered SMSF identify for non-3GPP access.

In Step 6, the MTC-IWF/SCEF/NEF selects a suitable SMS-SC based on configured information. The MTC-IWF/SCEF/NEF sends a Device Trigger Request message to the SMS-SC with SMS serving node identities besides other information such as the trigger payload and application identifier. In some embodiments, selecting a suitable SMS-SC depends on one or more of: the UE identity; the application identity; load balancing; and/or how close the SMS-SC is. [0089] 5G domain SMS serving nodes are obtained from UDM in Step 5, but as described above, the device trigger request does not support a UE registered in 5G system, extension on the protocol is needed to enable the possibility for MTC-IWF/SCEF/NEF to inform the SMSC with registered SMSF identity for 3GPP access and/or registered SMSF identity for non-3GPP access.

In some embodiments, the detailed behavior of MTC-IWF/SCEF/NET as cited above is updated such that the MTC-IWF/SCEF/NEF shall retrieve the 5G domain SMS serving node identities from UDM and shall include identities of registered SMSF for 3GPP access and/or registered SMSF for non-3GPP access in the Device Trigger Request to the SMSC. In some embodiments, the address (i.e., the SMSF address) could be either a MAP E164 number address, a diameter address in terms of a combination of name and realm, and/or any combination of these. In some embodiments, E164 Number Mapping (ENUM) is a standard adopted by the Internet Engineering Task Force (IETF) that uses the Domain Name System (DNS) to map telephone numbers to web addresses or uniform resource locators (URL). The ENUM standard might provide a single number to replace multiple numbers and/or addresses.

In Step 7, the SMS-SC sends a Device Trigger Answer message to the MTC-IWF/SCEF/NEF to confirm that the submission of the SMS has been accepted by the SMS-SC. In some embodiments, the detailed behavior of SMS-SC as described above is updated such that:
If there are routing information (i.e. MSC or MME, SGSN, SMSF for 3GPP access, SMSF for non-3GPP access, IP-SM-GW identities serving the UE for SMS) present in the request, the SMS-SC shall use the information for delivery of device trigger request for the UE. The SMS-SC shall return a Result Code of DIAMETER_SUCCESS to the MTC-IWF.
If there is no routing information (i.e. MSC or MME, SGSN, SMSF for 3GPP access, SMSF for non-3GPP access, IP-SM-GW identities serving the UE for SMS) present in the request, the SMS-SC shall send a Report-SM-Delivery-Status message to the HLR/UDM in order to update the MWD in the HLR/UDM (see 3GPP TS 23.040).

In Step 8, the MTC-IWF/SCEF/NEF sends a Device Trigger delivery response to the AS/SCS/AF to indicate if the Device Trigger Request has been accepted for delivery to the UE.

In Step 9, the SMS-SC together with SMS-GMSC performs MT-SMS delivery, device trigger is contained as SMS payload. Depends on the available SMSF serving nodes provided in the Device Trigger Request in Step 6, this MT-SMS delivery could be either through the SMSF for 3GPP access and/or through the SMSF for non-3GPP access, which one should be tried first depends on local policy on SMS-SC. SMSF should be based on the local context to find the appropriate AMF instance (for 3GPP access and/or for non-3GPP access) to delivery SMS to UE over Non-Access Stratum (NAS) signaling.

In Step 10, if the MT-SMS message delivery fails or when the message delivery succeeds, the SMS-SC shall send a Delivery-Report-Request (DRR) to the MTC-IWF/SCEF/NEF. In Step 11, the MTC-IWF/SCEF/NEF shall notify the SCS/AS/AF of the outcome of a device trigger request by sending a Device-Notification-Request to the SCS/AS/AF. In Step 12 the SCS/AS/AF shall acknowledge the receipt of the Device-Notification-Request by sending to the MTC-IWF/SCEF/NEF a Device-Notification-Answer.

In Step 13, the Delivery-Report-Answer (DRA), is sent from the MTC-IWF/SCEF/NEF to the SMS-SC to acknowledge the reception of Delivery-Report-Request. In Step 14, once the device trigger is received, the UE takes specific actions based on the content of the received device trigger payload. This action typically involves initiation of immediate or later communication with the AF.

Some embodiments are based on the Diameter protocol, but without loss of the generality, if the device trigger request is based on REST/HTTP protocols, for devices registered in 5G system, the identity of SMSF for 3GPP access and SMSF for non-3GPP access could be contained in the HTTP Message body of the Device Trigger Request. Any of the embodiments discussed herein could also use this protocol instead or in addition.

This enhances the T4 device trigger request from MTC-IWF/SCEF/NEF to SMSC by extending the protocol information elements for containing of SMSF for 3GPP access and/or SMSF for non-3GPP access, and the corresponding SMSF address could either be a MAP number address or a Diameter address in the form of a combination of name and realm. This enables support for the device trigger procedure when the UE device is located in a 5G system.

As discussed above, in some embodiments, the detailed behavior of MTC-IWF/SCEF/NET is updated such that the MTC-IWF/SCEF/NEF shall retrieve the 5G domain SMS serving node identities from UDM and shall include identities of registered SMSF for 3GPP access and/or registered SMSF for non-3GPP access in the Device Trigger Request to the SMSC. In some embodiments, the address (i.e., the SMSF address) could be either a MAP E164 number address, a diameter address in terms of a combination of name and realm, and/or any combination of these. Some of these are included in Table 3 below which is an updated version of Table 1 from above.

TABLE 3
From Table 5.2.1.1/1(update highlighted): Device Trigger Request

| Information | Mapping to | | |
|---|---|---|---|
| Element Name | Diameter AVP | Cat. | Description |
| User Identifier | User- | M | This information element shall contain the IMSI |
| (See 3GPP TS | Identifier | | of the UE the trigger is to be applied, formatted |
| 29.336 [12]) | | | according to 3GPP TS 23.003 [8], clause 2.2. |
| | | | This Information Element may contain the |
| | | | international ISDN number of the UE the device |
| | | | trigger was delivered, formatted according to |
| | | | 3GPP TS 23.003 [8], clause 3.3. The ISDN |
| | | | number shall be present if it is available to the |
| | | | MTC-IWF. |
| | | | This Information Element may contain the |
| | | | external identifier of the UE the device trigger |
| | | | was delivered, formatted according to 3GPP TS |
| | | | 23.003 [8], clause 19.7.2. The external |
| | | | identifier shall be present if it is available to the |
| | | | MTC-IWF. |
| SM RP SMEA | SM-RP-SMEA | M | This Information Element shall contain the SME |
| (See 3GPP TS | | | address of the Service Capability Server that is |
| 29.338 [13]) | | | requesting a device trigger to the UE. It shall |
| | | | be encoded according to the formatting rules of |
| | | | the address fields described in |
| | | | 3GPP TS 23.040 [9]. |
| Payload (See | Payload | M | This information element shall contain the |
| 3GPP TS 29.368 | | | device triggering payload as received over the |
| [15]) | | | Tsp. |
| | | | For device trigger recall, this IE shall be empty. |
| Serving Node | Serving-Node | C | This information element shall contain the |
| Identity | | | serving node identity, i.e., |
| (See 3GPP TS | | | SMSF/SGSN/MME/MSC identity serving the UE. |
| 29.173 [14]) | | | It shall be present if it is available to the MTC- |
| | | | IWF, e.g., the MTC-IWF retrieved this |
| | | | information from the HSS. |
| Additional | Additional- | C | This information element shall contain another |
| Serving Node | Serving-Node | | serving node identity, e.g., |
| Identity | | | SMSF/SGSN/MME/MSC identity, if there is any |
| (See 3GPP TS | | | serving the UE. |
| 29.173 [14]) | | | There may be multiple instances of this |
| | | | information elements. |
| Trigger | Reference- | C | This information element shall contain the |
| Reference | Number | | Reference Number related to the device trigger |
| Number | | | request. |
| (See 3GPP TS | | | It shall be present if it is available to the MTC- |
| 29.368 [15]) | | | IWF, e.g., the MTC-IWF received this |
| | | | information over Tsp. |
| Old Trigger | Old- | C | This information element shall contain the |
| Reference | Reference- | | Reference Number of the device trigger to be |
| Number | Number | | replaced. |
| (See 3GPP TS | | | It shall be present if it is available to the MTC- |
| 29.368 [15]) | | | IWF, e.g., the MTC-IWF received this |
| | | | information over Tsp. |
| Validity Time | Validity-Time | C | This information element shall contain the |
| (See 3GPP TS | | | validity time of the device trigger request. |
| 29.368 [15]) | | | It shall be present if it is available to the MTC- |
| | | | IWF, e.g., the MTC-IWF received this |
| | | | information over Tsp. |
| Priority | Priority- | C | This information element shall contain the |
| Indication | Indication | | priority of the device trigger request. |
| (See 3GPP TS | | | It shall be present if it is available to the MTC- |
| 29.368 [15]) | | | IWF, e.g., the MTC-IWF received this |
| | | | information over Tsp. |
| SMS Application | SMS- | C | This information element shall contain the |
| Port ID | Application- | | Application Port ID of the triggering application |
| (See 3GPP TS | Port-ID | | for the device trigger request. |
| 29.368 [15]) | | | It shall be present if it is available to the MTC- |
| | | | IWF, e.g., the MTC-IWF received this |
| | | | information over Tsp. |
| Supported | Supported- | 0 | If present, this information element shall |
| Features | Features | | contain the list of features supported by the |
| (See 3GPP TS | | | origin host. |
| 29.229 [6]) | | | |
| Trigger-Action | Trigger- | C | This information element shall be present for |
| (See 6.3.6) | Action | | device trigger action replace or recall. |
| | | | This information element may be present for a |
| | | | normal device. |

Additionally, in some embodiments, the definition of Serving Node Identity and Additional Serving Node Identity should also be extended with SMSF identity for 3GPP access and SMSF identity for non-3GPP access as in below proposal (change highlighted). The Serving-Node AVP is of type Grouped and it shall contain the name/number of the serving node to be used for T4-triggering. It is originally defined in 3GPP TS 29.173:
Serving-Node::=<AVP header: 2401 10415>
   [SMSF-NF-Identity]
   [SMSF-3GPP-Name]
   [SMSF-3GPP-Realm]
   [SMSF-3GPP-Number]
   [SMSF-Non-3GPP-Name]
   [SMSF-Non-3GPP-Realm]
   [SMSF-Non-3GPP-Number]
   [SGSN-Name]
   [SGSN-Realm]
   [SGSN-Number]
   [MME-Name]
   [MME-Realm]
   [MME-Number-for-MT-SMS]
   [MSC-Number]
   [IP-SM-GW-Number]
   [IP-SM-GW-Name]
   [IP-SM-GW-Realm]
   *[AVP]

In some embodiments, the following combinations are allowed:
a) SGSN-Number
b) SGSN-Name & SGSN-Realm & SGSN-Number
c) MME-Name & MME-Realm & MME-Number-for-MT-SMS
d) MSC-Number
e) MSC-Number & MME-Name & MME-Realm
f) IP-SM-GW-Number
g) IP-SM-GW-Number & IP-SM-GW-Name & IP-SM-GW-Realm
h) SMSF-3GPP-Number
i) SMSF-3GPP-Name & SMSF-3GPP-Realm & SMSF-3GPP-Number
j) SMSF-Non-3GPP-Number
k) SMSF-Non-3GPP-Name & SMSF-Non-3GPP-Realm & SMSF-Non-3GPP-Number
l) SMSF-NF-Identity

In some embodiments, the Additional Serving-Node AVP is of type Grouped and when present it shall contain the name/number of an additional serving node to be used for T4-triggering. It is originally defined in 3GPP TS 29.173:

Additional-Serving-Node::=<AVP header: 2406 10415>
[SMSF-NF-Identity]
[SMSF-3GPP-Name]
[SMSF-3GPP-Realm]
[SMSF-3GPP-Number]
[SMSF-Non-3GPP-Name]
[SMSF-Non-3GPP-Realm]
[SMSF-Non-3GPP-Number]
[SGSN-Name]
[SGSN-Realm]
[SGSN-Number]
[MME-Name]
[MME-Realm]
[MME-Number-for-MT-SMS]
[MSC-Number]
*[AVP]

In some embodiments, the following combinations are allowed:
a) SGSN-Number
b) SGSN-Name & SGSN-Realm & SGSN-Number
c) MME-Name & MME-Realm & MME-Number-for-MT-SMS
d) MSC-Number
e) MSC-Number & MME-Name & MME-Realm
f) SMSF-3GPP-Number
g) SMSF-3GPP-Name & SMSF-3GPP-Realm & SMSF-3GPP-Number
h) SMSF-Non-3GPP-Number
i) SMSF-Non-3GPP-Name & SMSF-Non-3GPP-Realm & SMSF-Non-3GPP-Number
j) SMSF-NF-Identity

In some embodiments: SMSF-3GPP-Name is used for the name attribute of diameter address, of the SMSF for 3GPP access; SMSF-3GPP-Realm is used for the realm attribute of diameter address, of the SMSF for 3GPP access; SMSF-3GPP-Number is used for the MAP E164 number address, of the SMSF for 3GPP access; SMSF-Non-3GPP-Name is used for the name attribute of diameter address, of the SMSF for non-3GPP access; SMSF-Non-3GPP-Realm is used for the realm attribute of diameter address, of the SMSF for non-3GPP access; and/or SMSF-Non-3GPP-Number is used for the MAP E164 number address, of the SMSF for non-3GPP access.

For devices registered in 5G system, the SMS serving nodes shall be the registered SMSF for 3GPP access and/or the registered SMSF for non-3GPP access. But current Device Trigger Request is not allowed to contain the SMS serving nodes for 5G domain. Extend the Serving-Node and Additional-Serving-Node AVPs to contain SMSF identities for 3GPP access and/or SMSF identities for non-3GPP access. SMSF identities could be the MAP address and/or the Diameter address registered in UDM.

The following content may be added into the 3GPP TS 29.337:
* * * First Change * * * *

### 3 Definitions and Abbreviations

### 3.1 Abbreviations

For the purposes of the present document, the abbreviations given in TR 21.905 [1] and the following apply. An abbreviation defined in the present document takes precedence over the definition of the same abbreviation, if any, in TR 21.905 [1].
ABNF Augmented Backus-Naur Form
AVP Attribute-Value Pair
C Conditional
DRMP Diameter Routing Message Priority
DSCP Differentiated Services Code Point
IANA Internet Assigned Numbers Authority
MTC Machine-Type Communications
MTC-IWF MTC Interworking Function
O Optional
SCS Service Capability Server
SMSF Short Message Service Function
UDM Unified Data Management

### 4 General Description

The T4 reference point between the MTC-IWF and the SMS-SC is an intra PLMN interface, as defined in the 3GPP TS 23.682 [7].

This document describes the T4 interface related procedures, message parameters and protocol specifications.

The T4 interface allows transfer of device trigger from MTC-IWF to SMS-SC inside HPLMN domain, along with the serving SGSN/MME/MSC/SMSF identities, and allows SMS-SC to report to MTC-IWF the submission outcome of a device trigger and the success or failure of delivering the device trigger to the UE.

* * * Next Change * * * *

5.2.1.1 General

This procedure shall be used between the MTC-IWF and the SMS-SC for device trigger. The procedure shall be invoked by the MTC-IWF and is used:
to transfer device trigger to SMS-SC inside HPLMN domain;
to transfer to the SMS-SC the identities of the serving MSC or MME but not both, and/or SGSN, and/or SMSF for 3GPP access, and/or SMSF for non-3GPP access, and/or IP-SM-GW serving the user for SMS along with device trigger.
to transfer device trigger replace/recall message to SMS-SC inside HPLMN domain.

This procedure is mapped to the commands Device-Trigger-Request/Answer in the Diameter application specified in chapter 6. Tables 5.2.1.1/1 and 5.2.1.1/2 detail the involved information elements.

TABLE 5.2.1.1/1
Device Trigger Request

| Information | Mapping to | | |
|---|---|---|---|
| Element Name | Diameter AVP | Cat. | Description |
| User Identifier | User-Identifier | M | This information element shall contain the IMSI of the UE the trigger is |
| (See 3GPP TS | | | to be applied, formatted according to 3GPP TS 23.003 [8], clause 2.2. |
| 29.336 [12]) | | | This Information Element may contain the international ISDN number of |
| | | | the UE the device trigger was delivered, formatted according to 3GPP |
| | | | TS 23.003 [8], clause 3.3. The ISDN number shall be present if it is |
| | | | available to the MTC-IWF. |
| | | | This Information Element may contain the external identifier of the UE |
| | | | the device trigger was delivered, formatted according to 3GPP TS |
| | | | 23.003 [8], clause 19.7.2. The external identifier shall be present if it is |
| | | | available to the MTC-IWF. |
| SM RP SMEA | SM-RP-SMEA | M | This Information Element shall contain the SME address of the Service |
| (See 3GPP TS | | | Capability Server that is requesting a device trigger to the UE. It shall be |
| 29.338 [13]) | | | encoded according to the formatting rules of the address fields |
| | | | described in 3GPP TS 23.040 [9]. |
| Payload(See | Payload | M | This information element shall contain the device triggering payload as |
| 3GPP TS 29.368 | | | received over the Tsp. |
| [15] | | | For device trigger recall, this IE shall be empty. |
| Serving Node | Serving-Node | C | This information element shall contain the serving node identity, i.e. |
| Identity | | | SGSN/MME/MSC/SMSF identity serving the UE. |
| (See 3GPP TS | | | It shall be present if it is available to the MTC-IWF, e.g. the MTC-IWF |
| 29.173 [14]) | | | retrieved this information from the HSS/UDM. |
| Additional | Additional- | C | This information element shall contain another serving node identity, |
| Serving Node | Serving-Node | | e.g. SGSN/MME/MSC/SMSF identity, if there is any serving the UE. |
| Identity | | | There may be multiple instances of this information elements. |
| (See 3GPP TS | | | |
| 29.173 [14]) | | | |
| Trigger | Reference- | C | This information element shall contain the Reference Number related to |
| Reference | Number | | the device trigger request. |
| Number | | | It shall be present if it is available to the MTC-IWF, e.g. the MTC-IWF |
| (See 3GPP TS | | | received this information over Tsp. |
| 29.368 [15]) | | | |
| Old Trigger | Old- | C | This information element shall contain the Reference Number of the |
| Reference | Reference- | | device trigger to be replaced. |
| Number | Number | | It shall be present if it is available to the MTC-IWF, e.g. the MTC-IWF |
| (See 3GPP TS | | | received this information over Tsp. |
| 29.368 [15]) | | | |
| Validity Time | Validity-Time | C | This information element shall contain the validity time of the device |
| (See 3GPP TS | | | trigger request. |
| 29.368 [15]) | | | It shall be present if it is available to the MTC-IWF, e.g. the MTC-IWF |
| | | | received this information over Tsp. |
| Priority Indication | Priority- | C | This information element shall contain the priority of the device trigger |
| (See 3GPP TS | Indication | | request .. |
| 29.368 [15]) | | | It shall be present if it is available to the MTC-IWF, e.g. the MTC-IWF |
| | | | received this information over Tsp. |
| SMS Application | SMS- | C | This information element shall contain the Application Port ID of the |
| Port ID | Application- | | triggering application for the device trigger request. |
| (See 3GPP TS | Port-ID | | It shall be present if it is available to the MTC-IWF, e.g. the MTC-IWF |
| 29.368 [15]) | | | received this information over Tsp. |
| Supported | Supported- | O | If present, this information element shall contain the list of features |
| Features | Features | | supported by the origin host. |
| (See 3GPP TS | | | |
| 29.229 [6]) | | | |
| Trigger-Action | Trigger-Action | C | This information element shall be present for device trigger action |
| (See 6.3.6) | | | replace or recall. |
| | | | This information element may be present for a normal device. |

TABLE 5.2.1.1/2
Device Trigger Answer

| Information | Mapping to | | |
|---|---|---|---|
| Element Name | Diameter AVP | Cat. | Description |
| Result | Result-Code / | M | This IE shall contain the result of the operation. |
| | Experimental- | | The Result-Code AVP shall be used to indicate success / errors as defined |
| | | | in the Diameter base protocol (see IETF RFC 6733 [19]). |
| | | | The Experimental-Result AVP shall be used for T4 errors. This is a grouped |
| | | | AVP which shall contain the 3GPP Vendor ID in the Vendor-Id AVP, and the |
| | | | error code in the Experimental-Result-Code AVP. |
| (See 7) | Result | | The following errors are applicable: |
| | | | Service Centre Congestion; |
| | | | Invalid Short Message Entity Address; |
| | | | Subscriber not Service Centre Subscriber; |
| | | | SM Protocol Error; |
| | | | Trigger Replace failed; |
| | | | Trigger Recall failed; |
| | | | Original Message not pending. |
| MTC-Error- | MTC-Error- | O | If the Experimental Result indicates either |
| Diagnostic | Diagnostic | | “DIAMETER_ERROR_TRIGGER_REPLACE_FAILURE” or |
| | | | “DIAMETER_ERROR_ORIGINAL_MESSAGE_NOT_PENDING”, Error |
| | | | Diagnostic may be present to indicate the reason why the replace has failed. |
| Supported | Supported- | O | If present, this information element shall contain the list of features |
| Features | Features | | supported by the origin host. |
| (See 3GPP | | | |
| TS 29.229 | | | |
| [6]) | | | |
| Old Trigger | Old- | C | This information element shall be included if the SMS-SC was requested to |
| Reference | Reference- | | perform device trigger recall or replace. It shall contain the Reference |
| Number | Number | | Number of the device trigger which was intended to be replaced or recalled |
| (See 3GPP | | | in the request. |
| TS 29.368 | | | |
| [15]) | | | |
| Trigger- | Trigger-Action | C | This information element shall be present for device trigger action replace or |
| Action | | | recall. |
| (see 6.3.6) | | | This information element may be present for a normal device trigger. |

5.2.1.2 Detailed Behaviour of the MTC-IWF

The MTC-IWF shall make use of this procedure to transfer device trigger request received over Tsp interface from SCS to the SMS-SC.

If the MTC-IWF retrieved the IMSI and serving node identities of the UE from the HSS/UDM, the MTC-IWF shall include these identities in the request to the SMS-SC.

The MTC-IWF shall include the External Identifier of the UE if received over Tsp interface from SCS.

The MTC-IWF shall include the Old Trigger Reference Number if received over Tsp interface from SCS.

5.2.1.3 Detailed Behaviour of the SMS-SC

When receiving a Device Trigger Request, the SMS-SC shall check the identity of the UE received (i.e. IMSI or MSISDN) if it serves this UE. If not, a Result Code of DIAMETER_ERROR_USER_UNKNOWN shall be returned.

If the SM-RP-SMEA AVP contains an invalid SME address, the SMS-SC shall return a Result Code of DIAMETER_ERROR_INVALID_SME_ADDRESS.

If the SMS-SC cannot fulfil the received request due to congestion, it shall return a Result Code of DIAMETER_ERROR_SC_CONGESTION.

If there are routing information (i.e. MSC or MME, SGSN, SMSF for 3GPP access, SMSF for non-3GPP access, IP-SM-GW identities serving the UE for SMS) present in the request, the SMS-SC shall use the information for delivery of device trigger request for the UE. The SMS-SC shall return a Result Code of DIAMETER_SUCCESS to the MTC-IWF.

NOTE: If the IP-SM-GW address is received, the SMS-SC uses the IP-SM-GW as the serving node with highest priority for delivery of device trigger request for the UE.

If there is no routing information (i.e. MSC or MME, SGSN, SMSF for 3GPP access, SMSF for non-3GPP access, IP-SM-GW identities serving the UE for SMS) present in the request, the SMS-SC shall send a Report-SM-Delivery-Status message to the HLR/UDM in order to update the MWD in the HLR/UDM (see 3GPP TS 23.040 [9]).

If Trigger-Action is received from the MTC-IWF and set to TRIGGER (0), SMS-SC shall store the new trigger message received from MTC-IWF.

If Trigger-Action is received from the MTC-IWF and set to RECALL (1), SMS-SC checks if message corresponding to Reference-Number is pending. If trigger message is pending then SMS-SC deletes the old trigger message. The SMS-SC shall return Old-Reference-Number and a Result Code of DIAMETER_SUCCESS to the MTC-IWF. For the successful scenario the SMS-SC is not required to initiate a device trigger reporting to the device trigger of Old-Reference-Number. If trigger message is not pending then SMS-SC shall return a Result Code of DIAMETER_ERROR_ORIGINAL_MESSAGE_NOT_PENDING to the MTC-IWF.

If Trigger-Action is received from the MTC-IWF and set to REPLACE (2), SMS-SC checks if message corresponding to Old-Reference-Number is pending. If trigger message is pending then SMS-SC shall delete the old trigger message and store the new trigger message received from MTC-IWF. The SMS-SC shall return OLD-Reference-Number and a Result Code of DIAMETER_SUCCESS to the MTC-IWF. For the successful scenario the SMS-SC is not required to initiate a device trigger reporting to the device trigger of Old-Reference-Number. If trigger message is not pending then SMS-SC shall return OLD-Reference-Number and a Result Code of DIAMETER_ERROR_ORIGINAL_MESSAGE_NOT_PENDING to the MTC-IWF and shall interpret the trigger replace message as a new device trigger. If the SMS-SC fails to perform deletion of the old trigger or fails to store the new trigger, it shall not delete the old trigger and shall not store the new trigger and shall return result code of DIAMETER_ERROR_TRIGGER_REPLACE_FAILURE.

The SMS SC shall use the most appropriate cause code indicating the real reason for the unsuccessful handling of the request message.

If the SMS-SC cannot fulfil the received request for reasons not stated in the above steps, e.g. due to system failure, it shall stop processing the request and set Result-Code to DIAMETER_UNABLE_TO_COMPLY.

* * * Next Change * * * *

6.3 AVPs

The following table specifies the Diameter AVPs defined for the T4 interface protocol, their AVP Code values, types, possible flag values and whether or not the AVP may be encrypted. The Vendor-ID header of all AVPs defined in this specification shall be set to 3GPP (10415).

TABLE 6.3.1/1
T4 specific Diameter AVPs

| | | | | AVP Flag rules | | | | |
|---|---|---|---|---|---|---|---|---|
| | | Section | | | | Should | Must | May |
| Attribute Name | AVP Code | defined | Value Type | Must | May | not | not | Encr. |

| | | | | | | |
|---|---|---|---|---|---|---|
| SM-Delivery-Outcome-T4 | 3200 | 6.3.1 | Enumerated | M, V | | No |
| Absent-Subscriber-Diagnostic-T4 | 3201 | 6.3.2 | Enumerated | M, V | | No |
| Trigger-Action | 3202 | 6.3.6 | Unsigned32 | V | M | No |
| MTC-Error-Diagnostic | 3203 | 6.3.7 | Unsigned32 | V | M | No |

NOTE 1:
The AVP header bit denoted as “M”, indicates whether support of the AVP is required. The AVP header bit denoted as “V”, indicates whether the optional Vendor-ID field is present in the AVP header. For further details, see IETF RFC 6733 [19].
NOTE 2:
If the M-bit is set for an AVP and the receiver does not understand the AVP, it shall return a rejection. If the M-bit is not set for an AVP, the receiver shall not return a rejection, whether or not it understands the AVP. If the receiver understands the AVP but the M-bit value does not match with the definition in this table, the receiver shall ignore the M-bit.

The following table specifies the Diameter AVPs re-used by the T4 interface protocol from existing Diameter Applications, including a reference to their respective specifications and when needed, a short description of their use within T4.

Any other AVPs from existing Diameter Applications, except for the AVPs from Diameter base protocol specified in IETF RFC 6733 [19], do not need to be supported. The AVPs from Diameter base protocol specified in IETF RFC 6733 [19] are not included in table 6.3.1/2, but they may be re-used for the T4 protocol.

TABLE 6.3.1/2
T4 re-used Diameter AVPs

| Attribute Name | Reference | Comments | M-bit |
|---|---|---|---|
| User- | 3GPP TS 29.336 [12] | | |
| Identifier | | | |
| SM-RP- | 3GPP TS 29.338 [13] | | |
| SMEA | | | |
| Payload | 3GPP TS 29.368 [15] | | |
| Serving- | 3GPP TS 29.173 [14] | See 6.3.3 | |
| Node | | | |
| Additional- | 3GPP TS 29.173 [14] | See 6.3.4 | |
| Serving- | | | |
| Node | | | |
| Reference- | 3GPP TS 29.368 [15] | | |
| Number | | | |
| Old- | 3GPP TS 29.368 [15] | | |
| Reference- | | | |
| Number | | | |
| Validity- | IETF RFC 4006 [17] | | |
| Time | | | |
| Priority- | 3GPP TS 29.368 [15] | | |
| Indication | | | |
| SMS- | 3GPP TS 29.368 [15] | | |
| Application- | | | |
| Port-ID | | | |
| Supported- | 3GPP TS 29.229 [6] | | |
| Features | | | |
| Feature- | 3GPP TS 29.229 [6] | | |
| List-ID | | | |
| Feature- | 3GPP TS 29.229 [6] | | |
| List | | | |
| IP-SM-GW- | 3GPP TS 29.336 [12] | | |
| Name | | | |
| IP-SM-GW- | 3GPP TS 29.336 [12] | | |
| Realm | | | |
| IP-SM-GW- | 3GPP TS 29.336 [12] | | |
| Number | | | |
| MME- | 3GPP TS 29.272 [16] | | |
| Number- | | | |
| for-MT- | | | |
| SMS | | | |
| DRMP | IETF RFC 7944 [18] | see section 6.3.8 | Must |
| | | | not |
| | | | set |
| SMSF- | 3GPP TS 29.338 [13] | | |
| 3GPP- | | | |
| Number | | | |
| SMSF- | 3GPP TS 29.338 [13] | | |
| Non- | | | |
| 3GPP- | | | |
| Number | | | |
| SMSF- | 3GPP TS 29.338 [13] | | |
| 3GPP- | | | |
| Name | | | |
| SMSF- | 3GPP TS 29.338 [13] | | |
| Non- | | | |
| 3GPP- | | | |
| Name | | | |
| SMSF- | 3GPP TS 29.338 [13] | | |
| 3GPP- | | | |
| Realm | | | |

| | |
|---|---|
| SMSF- | 3GPP TS 29.338 [13] |
| Non- | |
| 3GPP- | |
| Realm | |

NOTE 1:
The M-bit settings for re-used AVPs override those of the defining specifications that are referenced. Values include: “Must set”, “Must not set”. If the M-bit setting is blank, than the defining specification applies.
NOTE 2:
If the M-bit is set for an AVP and the received does not understand the AVP, it shall return a rejection. If the M-bit is not set for an AVP, the receiver shall not return a rejection, whether or not it understands the AVP. If the received understands the AVP but the M-bit value does not match with the definition in this table, the receiver shall ignore the M-bit.

* * * Next Change * * * *

6.3.3 Serving-Node

The Serving-Node AVP is of type Grouped and it shall contain the name/number of the serving node to be used for T4-triggering. It is originally defined in 3GPP TS 29.173 [8].

Serving-Node::=<AVP header: 2401 10415>
[SMSF-3GPP-Name]
[SMSF-3GPP-Realm]
[SMSF-3GPP-Number]
[SMSF-Non-3GPP-Name]
[SMSF-Non-3GPP-Realm]
[SMSF-Non-3GPP-Number]
[SGSN-Name]
[SGSN-Realm]
[SGSN-Number]
[MME-Name]
[MME-Realm]
[MME-Number-for-MT-SMS]
[MSC-Number]
[IP-SM-GW-Number]
[IP-SM-GW-Name]
[IP-SM-GW-Realm]
*[AVP]

The following combinations are allowed:
a) SGSN-Number
b) SGSN-Name & SGSN-Realm & SGSN-Number
c) MME-Name & MME-Realm & MME-Number-for-MT-SMS
d) MSC-Number
e) MSC-Number & MME-Name & MME-Realm
f) IP-SM-GW-Number
g) IP-SM-GW-Number & IP-SM-GW-Name & IP-SM-GW-Realm
h) SMSF-3GPP-Number
i) SMSF-3GPP-Name & SMSF-3GPP-Realm & SMSF-3GPP-Number
j) SMSF-Non-3GPP-Number
k) SMSF-Non-3GPP-Name & SMSF-Non-3GPP-Realm & SMSF-Non-3GPP-Number

* * * Next Change * * * *

6.3.4 Additional-Serving-Node

The Additional Serving-Node AVP is of type Grouped and when present it shall contain the name/number of an additional serving node to be used for T4-triggering. It is originally defined in 3GPP TS 29.173 [8],

Additional-Serving-Node::=<AVP header: 2406 10415>
[SMSF-3GPP-Name]
[SMSF-3GPP-Realm]
[SMSF-3GPP-Number]
[SMSF-Non-3GPP-Name]
[SMSF-Non-3GPP-Realm]
[SMSF-Non-3GPP-Number]
[SGSN-Name]
[SGSN-Realm]
[SGSN-Number]
[MME-Name]
[MME-Realm]
[MME-Number-for-MT-SMS]
[MSC-Number]
*[AVP]

The following combinations are allowed:
a) SGSN-Number
b) SGSN-Name & SGSN-Realm & SGSN-Number
c) MME-Name & MME-Realm & MME-Number-for-MT-SMS
d) MSC-Number
e) MSC-Number & MME-Name & MME-Realm
f) SMSF-3GPP-Number
g) SMSF-3GPP-Name & SMSF-3GPP-Realm & SMSF-3GPP-Number
h) SMSF-Non-3GPP-Number
i) SMSF-Non-3GPP-Name & SMSF-Non-3GPP-Realm & SMSF-Non-3GPP-Number

* * * End of Changes * * * *

FIG. 9 is a schematic block diagram of a core network node 900 according to some embodiments of the present disclosure. The core network node 900 may be, for example, a MTC-IWF, a SCEF, a NEF, and/or a SMS-SC described herein. As illustrated, the core network node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. The one or more processors 904 operate to provide one or more functions of a core network node 900 as described herein. In some embodiments, the function(s) are implemented in software that is stored, e.g., in the memory 906 and executed by the one or more processors 904.

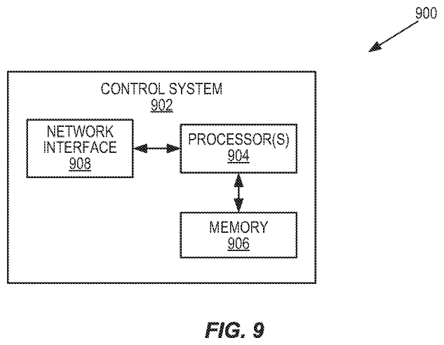

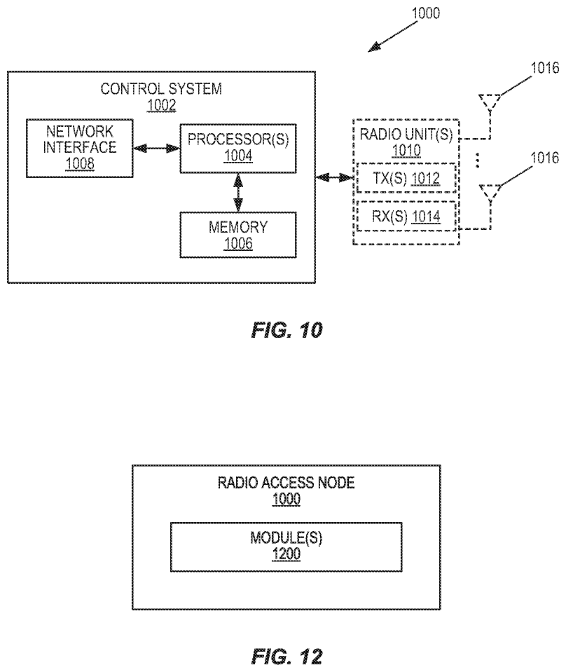

FIG. 10 is a schematic block diagram of a radio access node 1000 according to some embodiments of the present disclosure. Optional features are represented by dashed boxes. The radio access node 1000 may be, for example, a base station 102 or 106 or a network node that implements all or part of the functionality of the base station 102 or gNB described herein. As illustrated, the radio access node 1000 includes a control system 1002 that includes one or more processors 1004 (e.g., CPUs, ASICs, FPGAs, and/or the like), memory 1006, and a network interface 1008. The one or more processors 1004 are also referred to herein as processing circuitry. In addition, the radio access node 1000 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of a radio access node 1000 as described herein. In some embodiments, the function(s) are implemented in software that is stored, e.g., in the memory 1006 and executed by the one or more processors 1004.

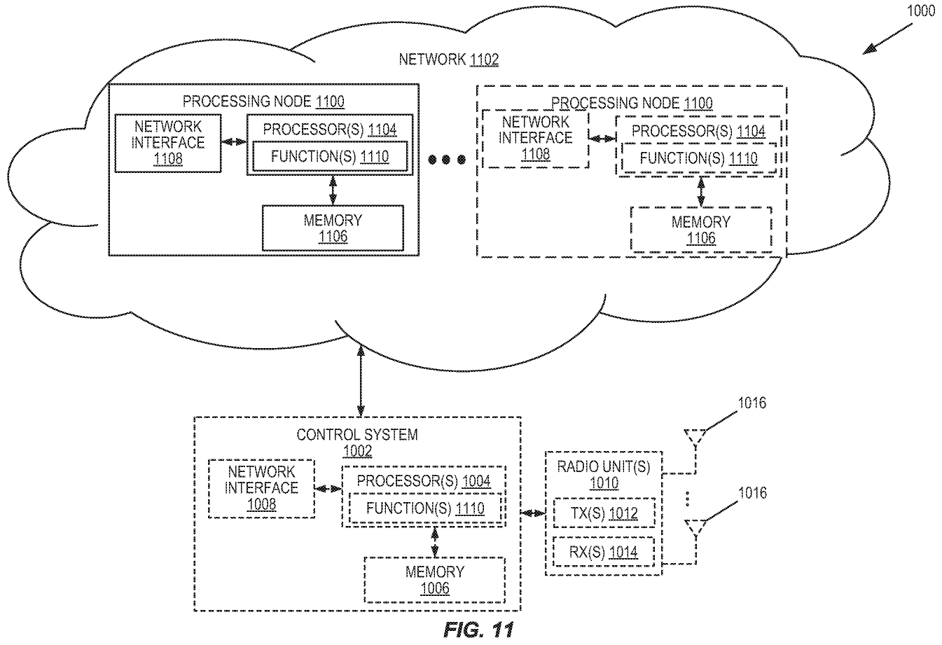

FIG. 11 is a schematic block diagram that illustrates a virtualized embodiment of the radio access node 1000 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1000 in which at least a portion of the functionality of the radio access node 1000 is implemented as a virtual component(s) (e.g., via a virtual machine(s) executing on a physical processing node(s) in a network(s)). As illustrated, in this example, the radio access node 1000 may include the control system 1002 and/or the one or more radio units 1010, as described above. The control system 1002 may be connected to the radio unit(s) 1010 via, for example, an optical cable or the like. The radio access node 1000 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICs, FPGAs, and/or the like), memory 1106, and a network interface 1108.

In this example, functions 1110 of the radio access node 1000 described herein are implemented at the one or more processing nodes 1100 or distributed across the one or more processing nodes 1100 and the control system 1002 and/or the radio unit(s) 1010 in any desired manner. In some particular embodiments, some or all of the functions 1110 of the radio access node 1000 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s).

In some embodiments, a computer program including instructions which, when executed by at least one processor, causes the at least one processor to carry out the functionality of radio access node 1000 or a node (e.g., a processing node 1100) implementing one or more of the functions 1110 of the radio access node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the radio access node 1000 according to some other embodiments of the present disclosure. The radio access node 1000 includes one or more modules 1200, each of which is implemented in software. The module(s) 1200 provide the functionality of the radio access node 1000 described herein. This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

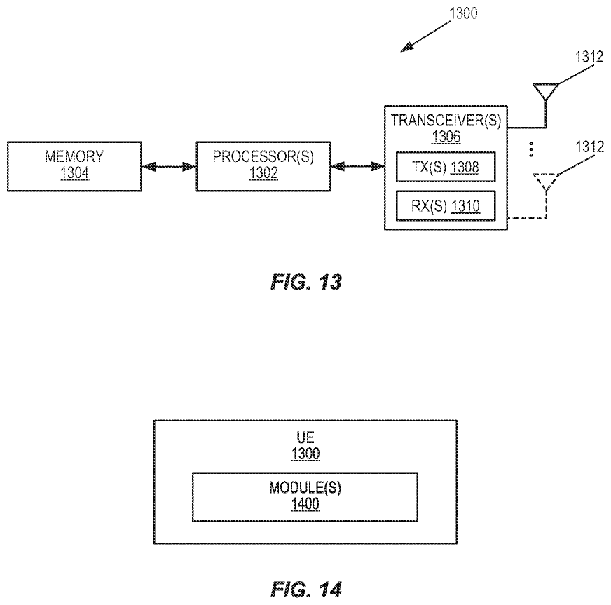

FIG. 13 is a schematic block diagram of a wireless communication device 1300 according to some embodiments of the present disclosure. As illustrated, the wireless communication device 1300 includes one or more processors 1302 (e.g., CPUs, ASICs, FPGAs, and/or the like), memory 1304, and one or more transceivers 1306 each including one or more transmitters 1308 and one or more receivers 1310 coupled to one or more antennas 1312. The transceiver(s) 1306 includes radio-front end circuitry connected to the antenna(s) 1312 that is configured to condition signals communicated between the antenna(s) 1312 and the processor(s) 1302, as will be appreciated by on of ordinary skill in the art. The processors 1302 are also referred to herein as processing circuitry. The transceivers 1306 are also referred to herein as radio circuitry. In some embodiments, the functionality of the wireless communication device 1300 described above may be fully or partially implemented in software that is, e.g., stored in the memory 1304 and executed by the processor(s) 1302. Note that the wireless communication device 1300 may include additional components not illustrated in FIG. 13 such as, e.g., one or more user interface components (e.g., an input/output interface including a display, buttons, a touch screen, a microphone, a speaker(s), and/or the like and/or any other components for allowing input of information into the wireless communication device 1300 and/or allowing output of information from the wireless communication device 1300), a power supply (e.g., a battery and associated power circuitry), etc.

In some embodiments, a computer program including instructions which, when executed by at least one processor, causes the at least one processor to carry out the functionality of the wireless communication device 1300 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the wireless communication device 1300 according to some other embodiments of the present disclosure. The wireless communication device 1300 includes one or more modules 1400, each of which is implemented in software. The module(s) 1400 provide the functionality of the wireless communication device 1300 described herein.

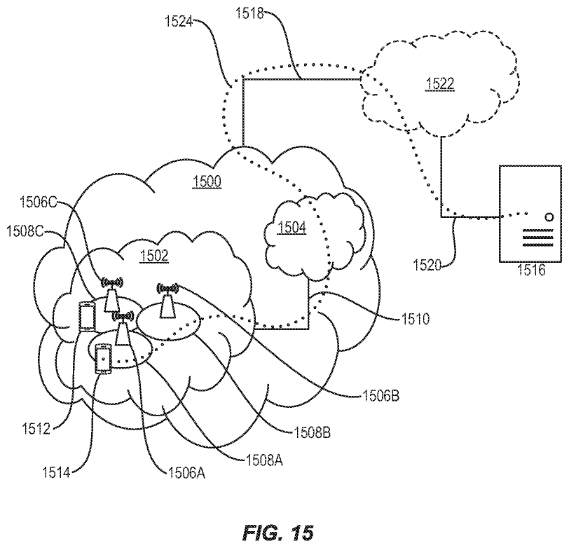

With reference to FIG. 15, in accordance with an embodiment, a communication system includes a telecommunication network 1500, such as a 3GPP-type cellular network, which comprises an access network 1502, such as a RAN, and a core network 1504. The access network 1502 comprises a plurality of base stations 1506A, 1506B, 1506C, such as Node Bs, eNBs, gNBs, or other types of wireless Access Points (APs), each defining a corresponding coverage area 1508A, 1508B, 1508C. Each base station 1506A, 1506B, 1506C is connectable to the core network 1504 over a wired or wireless connection 1510. A first UE 1512 located in coverage area 1508C is configured to wirelessly connect to, or be paged by, the corresponding base station 1506C. A second UE 1514 in coverage area 1508A is wirelessly connectable to the corresponding base station 1506A. While a plurality of UEs 1512, 1514 are illustrated in this example, the disclosed embodiments are equally applicable to a situation where a sole UE is in the coverage area or where a sole UE is connecting to the corresponding base station 1506.

The telecommunication network 1500 is itself connected to a host computer 1516, which may be embodied in the hardware and/or software of a standalone server, a cloud-implemented server, a distributed server, or as processing resources in a server farm. The host computer 1516 may be under the ownership or control of a service provider, or may be operated by the service provider or on behalf of the service provider. Connections 1518 and 1520 between the telecommunication network 1500 and the host computer 1516 may extend directly from the core network 1504 to the host computer 1516 or may go via an optional intermediate network 1522. The intermediate network 1522 may be one of, or a combination of more than one of, a public, private, or hosted network; the intermediate network 1522, if any, may be a backbone network or the Internet; in particular, the intermediate network 1522 may comprise two or more sub-networks (not shown).

The communication system of FIG. 15 as a whole enables connectivity between the connected UEs 1512, 1514 and the host computer 1516. The connectivity may be described as an Over-the-Top (OTT) connection 1524. The host computer 1516 and the connected UEs 1512, 1514 are configured to communicate data and/or signaling via the OTT connection 1524, using the access network 1502, the core network 1504, any intermediate network 1522, and possible further infrastructure (not shown) as intermediaries. The OTT connection 1524 may be transparent in the sense that the participating communication devices through which the OTT connection 1524 passes are unaware of routing of uplink and downlink communications. For example, the base station 1506 may not or need not be informed about the past routing of an incoming downlink communication with data originating from the host computer 1516 to be forwarded (e.g., handed over) to a connected UE 1512. Similarly, the base station 1506 need not be aware of the future routing of an outgoing uplink communication originating from the UE 1512 towards the host computer 1516.

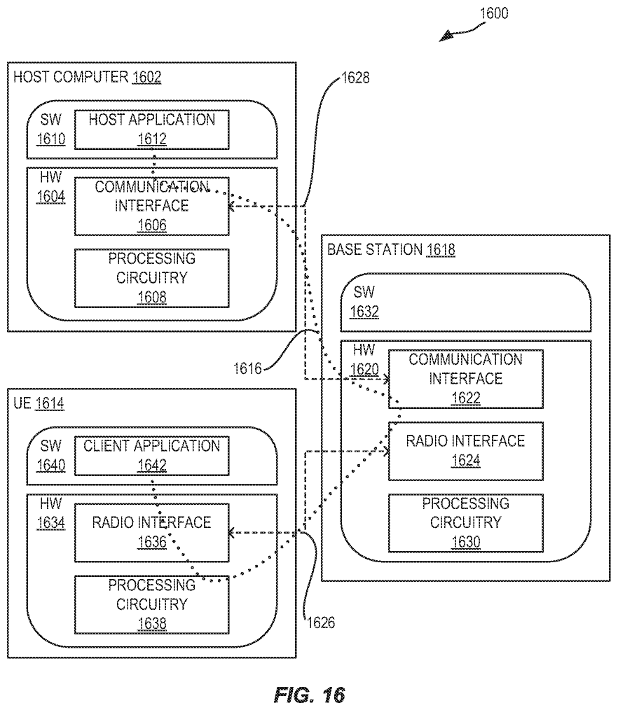

Example implementations, in accordance with an embodiment, of the UE, base station, and host computer discussed in the preceding paragraphs will now be described with reference to FIG. 16. In a communication system 1600, a host computer 1602 comprises hardware 1604 including a communication interface 1606 configured to set up and maintain a wired or wireless connection with an interface of a different communication device of the communication system 1600. The host computer 1602 further comprises processing circuitry 1608, which may have storage and/or processing capabilities. In particular, the processing circuitry 1608 may comprise one or more programmable processors, ASICs, FPGAs, or combinations of these (not shown) adapted to execute instructions. The host computer 1602 further comprises software 1610, which is stored in or accessible by the host computer 1602 and executable by the processing circuitry 1608. The software 1610 includes a host application 1612. The host application 1612 may be operable to provide a service to a remote user, such as a UE 1614 connecting via an OTT connection 1616 terminating at the UE 1614 and the host computer 1602. In providing the service to the remote user, the host application 1612 may provide user data which is transmitted using the OTT connection 1616.

The communication system 1600 further includes a base station 1618 provided in a telecommunication system and comprising hardware 1620 enabling it to communicate with the host computer 1602 and with the UE 1614. The hardware 1620 may include a communication interface 1622 for setting up and maintaining a wired or wireless connection with an interface of a different communication device of the communication system 1600, as well as a radio interface 1624 for setting up and maintaining at least a wireless connection 1626 with the UE 1614 located in a coverage area (not shown in FIG. 16) served by the base station 1618. The communication interface 1622 may be configured to facilitate a connection 1628 to the host computer 1602. The connection 1628 may be direct or it may pass through a core network (not shown in FIG. 16) of the telecommunication system and/or through one or more intermediate networks outside the telecommunication system. In the embodiment shown, the hardware 1620 of the base station 1618 further includes processing circuitry 1630, which may comprise one or more programmable processors, ASICs, FPGAs, or combinations of these (not shown) adapted to execute instructions. The base station 1618 further has software 1632 stored internally or accessible via an external connection.

The communication system 1600 further includes the UE 1614 already referred to. The UE's 1614 hardware 1634 may include a radio interface 1636 configured to set up and maintain a wireless connection 1626 with a base station serving a coverage area in which the UE 1614 is currently located. The hardware 1634 of the UE 1614 further includes processing circuitry 1638, which may comprise one or more programmable processors, ASICs, FPGAs, or combinations of these (not shown) adapted to execute instructions. The UE 1614 further comprises software 1640, which is stored in or accessible by the UE 1614 and executable by the processing circuitry 1638. The software 1640 includes a client application 1642. The client application 1642 may be operable to provide a service to a human or non-human user via the UE 1614, with the support of the host computer 1602. In the host computer 1602, the executing host application 1612 may communicate with the executing client application 1642 via the OTT connection 1616 terminating at the UE 1614 and the host computer 1602. In providing the service to the user, the client application 1642 may receive request data from the host application 1612 and provide user data in response to the request data. The OTT connection 1616 may transfer both the request data and the user data. The client application 1642 may interact with the user to generate the user data that it provides.

It is noted that the host computer 1602, the base station 1618, and the UE 1614 illustrated in FIG. 16 may be similar or identical to the host computer 1516, one of the base stations 1506A, 1506B, 1506C, and one of the UEs 1512, 1514 of FIG. 15, respectively. This is to say, the inner workings of these entities may be as shown in FIG. 16 and independently, the surrounding network topology may be that of FIG. 15.

In FIG. 16, the OTT connection 1616 has been drawn abstractly to illustrate the communication between the host computer 1602 and the UE 1614 via the base station 1618 without explicit reference to any intermediary devices and the precise routing of messages via these devices. The network infrastructure may determine the routing, which may be configured to hide from the UE 1614 or from the service provider operating the host computer 1602, or both. While the OTT connection 1616 is active, the network infrastructure may further take decisions by which it dynamically changes the routing (e.g., on the basis of load balancing consideration or reconfiguration of the network).

The wireless connection 1626 between the UE 1614 and the base station 1618 is in accordance with the teachings of the embodiments described throughout this disclosure. One or more of the various embodiments improve the performance of OTT services provided to the UE 1614 using the OTT connection 1616, in which the wireless connection 1626 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 1616 between the host computer 1602 and the UE 1614, in response to variations in the measurement results. The measurement procedure and/or the network functionality for reconfiguring the OTT connection 1616 may be implemented in the software 1610 and the hardware 1604 of the host computer 1602 or in the software 1640 and the hardware 1634 of the UE 1614, or both. In some embodiments, sensors (not shown) may be deployed in or in association with communication devices through which the OTT connection 1616 passes; the sensors may participate in the measurement procedure by supplying values of the monitored quantities exemplified above, or supplying values of other physical quantities from which the software 1610, 1640 may compute or estimate the monitored quantities. The reconfiguring of the OTT connection 1616 may include message format, retransmission settings, preferred routing, etc.; the reconfiguring need not affect the base station 1618, and it may be unknown or imperceptible to the base station 1618. Such procedures and functionalities may be known and practiced in the art. In certain embodiments, measurements may involve proprietary UE signaling facilitating the host computer's 1602 measurements of throughput, propagation times, latency, and the like. The measurements may be implemented in that the software 1610 and 1640 causes messages to be transmitted, in particular empty or ‘dummy’ messages, using the OTT connection 1616 while it monitors propagation times, errors, etc.

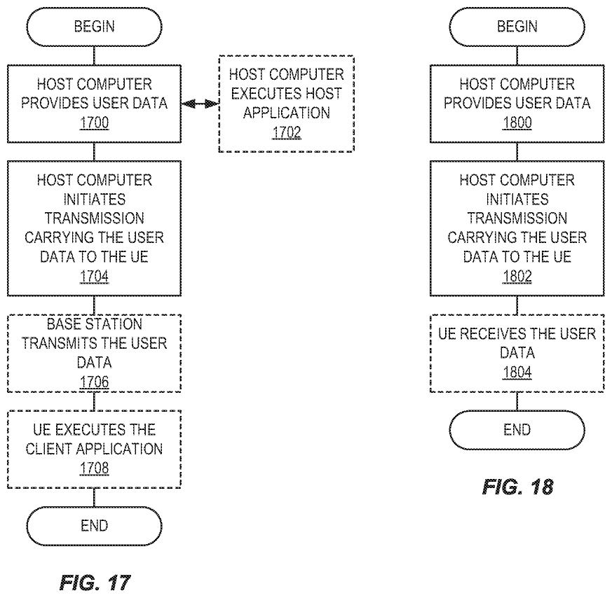

FIG. 17 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 17 will be included in this section. In step 1700, the host computer provides user data. In sub-step 1702 (which may be optional) of step 1700, the host computer provides the user data by executing a host application. In step 1704, the host computer initiates a transmission carrying the user data to the UE. In step 1706 (which may be optional), the base station transmits to the UE the user data which was carried in the transmission that the host computer initiated, in accordance with the teachings of the embodiments described throughout this disclosure. In step 1708 (which may also be optional), the UE executes a client application associated with the host application executed by the host computer.

FIG. 18 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 18 will be included in this section. In step 1800 of the method, the host computer provides user data. In an optional sub-step (not shown) the host computer provides the user data by executing a host application. In step 1802, the host computer initiates a transmission carrying the user data to the UE. The transmission may pass via the base station, in accordance with the teachings of the embodiments described throughout this disclosure. In step 1804 (which may be optional), the UE receives the user data carried in the transmission.

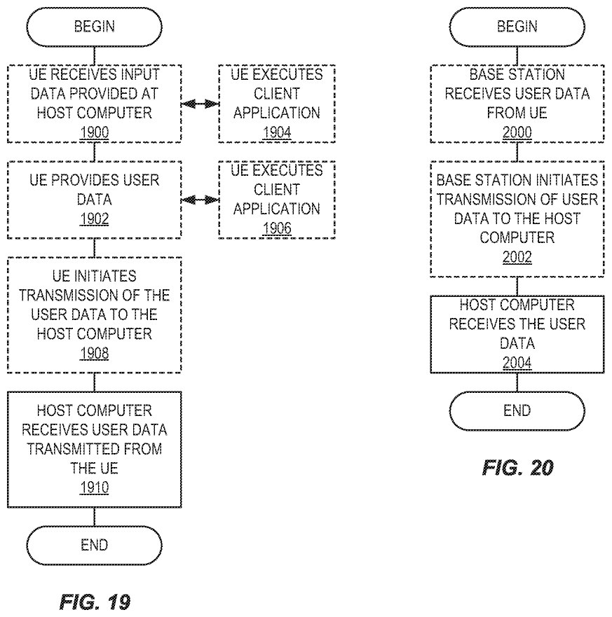

FIG. 19 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 19 will be included in this section. In step 1900 (which may be optional), the UE receives input data provided by the host computer. Additionally or alternatively, in step 1902, the UE provides user data. In sub-step 1904 (which may be optional) of step 1900, the UE provides the user data by executing a client application. In sub-step 1906 (which may be optional) of step 1902, the UE executes a client application which provides the user data in reaction to the received input data provided by the host computer. In providing the user data, the executed client application may further consider user input received from the user. Regardless of the specific manner in which the user data was provided, the UE initiates, in sub-step 1908 (which may be optional), transmission of the user data to the host computer. In step 1910 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station, and a UE which may be those described with reference to FIGS. 15 and 16. For simplicity of the present disclosure, only drawing references to FIG. 20 will be included in this section. In step 2000 (which may be optional), in accordance with the teachings of the embodiments described throughout this disclosure, the base station receives user data from the UE. In step 2002 (which may be optional), the base station initiates transmission of the received user data to the host computer. In step 2004 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the nodes may not need a fixed processor or memory, any computing resource and storage resource may be arranged from the nodes in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
ABNF Augmented Backus-Naur Form
AF Application Function
AMF Access and Mobility Function
AN Access Network
AP Access Point
AS Application Server
ASIC Application Specific Integrated Circuit
AUSF Authentication Server Function
AVP Attribute Value Pair
CDR Charging Data Record
CPU Central Processing Unit
DN Data Network
DNS Domain Name System
DRA Delivery-Report-Answer
DRMP Diameter Routing Message Priority
DRR Delivery-Report-Request
DCSP Differentiated Services Code Point
DSP Digital Signal Processor
eNB Enhanced or Evolved Node B
ENUM E164 Number Mapping
E-UTRA Evolved Universal Terrestrial Radio Access
E-UTRAN Evolved Universal Terrestrial Radio Access Network
FPGA Field Programmable Gate Array
GERAN Global System for Mobile Communications Enhanced Data Rates for Global System for Mobile Communications Evolution Radio Access Network
gNB New Radio Base Station
gNB-DU New Radio Base Station Distributed Unit
HLR Home Location Register
HPLMN Home Public Land Mobile Network
HSS Home Subscriber Server
IANA Internet Assigned Numbers Authority
IETF Internet Engineering Task Force
IMSI International Mobile Subscriber Identity
IoT Internet of Things
IP Internet Protocol
IP-SM-GW IP-Short-Message-Gateway
LTE Long Term Evolution
MME Mobility Management Entity
MSC Mobile Switching Center
MSISDN Mobile Subscriber Integrated Services Digital Network
MTC Machine Type Communication
MTC-IWF MTC-InterWorking Function
MWD Messages Waiting Data
NAS Non-Access Stratum
NEF Network Exposure Function
NF Network Function
NG-RAN Next Generation Radio Access Network
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SCS Service Capability Server
SGSN Serving General Packet Radio Service Support Node
SME Short Message Entity
SMF Session Management Function
SMSC Short Message Service Center
SMSF Short Message Service Function
SMS-SC Short Message Service-Service Centre
TCI Transmission Configuration Indicator
TRP Transmission/Reception Point
TS Technical Specification
UDM Unified Data Management
UDR Unified Data Repository
UE User Equipment
UMTS Universal Mobile Telecommunications Service
UPF User Plane Function
URI Uniform Resource Identifier
URL Uniform Resource Locator
UTRAN Universal Terrestrial Radio Access Network

Those skilled in the art will recognize improvements and modifications to the embodiments of the present disclosure. All such improvements and modifications are considered within the scope of the concepts disclosed herein.

1. A method at a core network node for device triggering for 5G, devices, comprising at least one of:
receiving a request to trigger the 5G device; and
transmitting a Device Trigger Request message to an SMS-SC (Short Message Service-Service Center) with one or more SMS serving node identities to trigger the 5G device.

2. The method of claim 1 wherein the core network node is one of: an MTC-IWF (Machine Type Communication-InterWorking Function) an SCEF (Service Capability Exposure Function); and an NEF (Network Exposure Function).

3. The method of claim 1 wherein the request to trigger the 5G device is received from one of: an AS (Application Server); SCS (Service Capability Server); and an AF (Application Function).

4. The method of claim 1 wherein the request to trigger the 5G device comprises a Device Action Request.

5. The method of claim 1 wherein the request to trigger the 5G device comprises one or more of: an application identity; a trigger payload; and an identity of the 5G device.

6. The method of claim 1 wherein the Device Trigger Request message comprises one or more of: an application identity; a trigger payload; and an identity of the 5G device.

7. The method of claim 1 further comprising:
prior to transmitting the Device Trigger Request message, requesting 5G domain UE (User Equipment) registered SMSF (Short Message Service Function) identities for the 5G device.

8. The method of claim 1 further comprising:
prior to transmitting the Device Trigger Request message, receiving the 5G domain UE registered SMSF identities for the 5G device.

9. The method of claim 7 wherein one or both requesting the 5G domain UE registered SMSF identities and receiving the 5G domain UE registered SMSF identities comprises one or both requesting and receiving the 5G domain UE registered SMSF identities from a UDM (Unified Data Management) node.

10. The method of claim 1 further comprising:
prior to transmitting the Device Trigger Request message, selecting a suitable SMS-SC based on configured information.

11. The method of claim 10 wherein selecting the suitable SMS-SC based on one or more from a group consisting of: the identity of the 5G device; the application identity; load balancing; and how close the SMS-SC is.

12. A method at an SMS-SC (Short Message Service-Service Center), for device triggering for 5G (Fifth Generation), devices, comprising at least one of:
receiving a Device Trigger Request message from a core network node with one or more SMS serving node identities to trigger the 5G device.

13. The method of claim 12 wherein the core network node is one of: an MTC-IWF (Machine Type Communication-InterWorking Function); an SCEF Service Capability Exposure Function); and an NEF (Network Exposure Function).

14. The method of claim 12 wherein the Device Trigger Request message comprises one or more of: an application identity; a trigger payload; and an identity of the 5G device.

15. The method of claim 1 further comprising:
transmitting, to the one or more SMS serving node identities, a device trigger for the 5G device.

16. The method of claim 15 wherein the device trigger is transmitted through one or more of a group consisting of: an SMSF (Short Message Service Function) for 3GPP (Third Generation Partnership Project) access; and an SMSF for non-3GPP access.

17. The method of claim 15 wherein the device trigger is contained as an SMS payload.

18. A core network node for device triggering for 5G (Fifth Generation) devices, comprising:
a processor; and
a memory coupled to the processor, the memory containing instructions executable by the processor, the core network node being operative to:
receive a request to trigger the 5G device; and
transmit a Device Trigger Request message to an SMS-SC (Short Message Service-Service Center), with one or more SMS serving node identities to trigger the 5G device.

19. The core network node according to claim 18, wherein the core network node is further operative to:
prior to transmitting the Device Trigger Request message, selecting the SMS-SC based on one or more of: the identity of the 5G device; the application identity; load balancing; and how close the SMS-SC is.

20. An SMS-SC (Short Message Service-Service Center) for device triggering for 5G (Fifth Generation) devices, comprising:
a processor; and
a memory coupled to the processor, the memory containing instructions executable by the processor, the SMS-SC being operative to:
receive a Device Trigger Request message from a core network node with one or more SMS serving node identities to trigger a 5G device.

21.-23. (canceled)
